(19) United States
(12) Patent Application Publication
(10) Pub. No.: US 2004/0093413 A1
(43) Pub. Date: May 13, 2004

(54) Selecting and managing time specified segments from a large continuous capture of network data

(76) Inventors: Timothy E. Bean, Pleasanton, CA (US); Gary Carter, Morgan Hill, CA (US); Aloke Bordia, Santa Clara, CA (US); Scott Pelger, San Jose, CA (US)

Correspondence Address: ERIC L. MASCHOFF, WORKMAN NYDEGGER, 1000 Eagle Gate Tower, 60 East South Temple, Salt Lake City, UT, 84111, US

(21) Appl. No.: 10/702,408

(22) Filed: Nov. 6, 2003

Related U.S. Application Data
(60) Provisional application No. 60/424,457, filed on Nov. 6, 2002.

(51) Int. Cl. G06F 15/173

(52) U.S. Cl. 709/224

(57) ABSTRACT

Analyzing data on a network. At a network monitoring computer, network traffic is captured during a period of time. The network traffic is compiled into sections. Information about the sections including, start time, end time, number of frames in the section and bytes/sec are compiled. At a user computer remote from the network monitoring computer, a histogram is stored. The histogram includes for substantially all of the captured network traffic, start time, end time, total frames and total bytes. The histogram also includes for each of the sections, the information about the sections.

### CROSS REFERENCE TO RELATED APPLICATIONS

This application claims the benefit of U.S. Provisional Application No. 60/424,457, filed Nov. 6, 2002, which is incorporated herein by this reference.

### BACKGROUND OF THE INVENTION

1. The Field of the Invention

The invention generally relates to the field of analyzing network data. More specifically, the invention relates to methods and apparatus for minimizing the amount of data that needs to be processed to present a network administrator with captured network traffic.

2. Description of the Related Art

Modern computer networks involve the transmission of large amounts of data at very high speeds across the networks. For example, in some networks, transmission rates as high as 10 Gbits/second are currently being used. Today, hardware and protocols that will support transmission rates up to 40 Gbits/second are being developed. Within these networks, transmission problems may occur intermittently.

Using network analysis tools, network administrators can identify and resolve various types of network problems. In some situations, network problems may be resolved by sampling a portion of the data transmitted across the network or by performing a statistical analysis on portions of the transmitted data. Other solutions require the collection of all data that traverses the network during a given time period. Collecting all of the data into a capture enables a network administrator to perform a detailed analysis on the collected data. However, recording network traffic that travels at such high transmission rates may result in very large captures. In fact, the resources used to process and view captures may be inadequate. For example, a 10 Gbits/second network can generate a 60 Gigabyte (GB) file in less than a minute. To perform a detailed analysis of the network data in a 60 GB capture, the 60 GB capture must be opened and analyzed on the network administrator's computer. Directly opening such a large file using a typical computer can take hours due to the data processing required to make the network data presentable to the network administrator. Additionally, such large captures require significant memory resources, the use of which can be burdensome to a computer system.

Prior attempts to reduce the processing requirements of captures include using filtering algorithms such that only data meeting a specified filter criteria is displayed to the network administrator. Generally, such filters are provided after the data has been captured, meaning that data is initially captured, then filtered. As a result, processing the capture by applying a filter may reduce the processing requirements, but can still take a lot of time. Additionally, the network administrator may not know exactly what to filter, making this a hit or miss solution.

Often, network administrators are encouraged to acquire personal computers that have faster CPUs and more memory to decrease the processing time of a particular file. Other proposed solutions include maintaining the capture on a remote high-end server or host and performing the processing in one place, one time. Remote users can view the processed results. In this way, the time to process the capture is incurred once and not by all the users.

One problem with these solutions is that network traffic is increasing exponentially faster on modern networks than the processing power and memory capacities of personal computers. Further, it may not be practical for many network administrators to have high-end servers dedicated to network troubleshooting. Additionally, even in the case where a remote server processes the data a first time, there is still the penalty of that initial processing.

Another challenge arises when a network administrator in one location needs to troubleshoot data collected in another location, because the analysis of high-speed networks typically requires the processing of large amounts of captured data, which cannot be quickly or easily transmitted to remote locations.

### BRIEF SUMMARY OF THE INVENTION

In one embodiment of the invention, a method of analyzing data on a network is disclosed. At a network monitoring computer, network traffic is captured during a period of time. The network traffic is compiled into sections. Information about the sections including: start time, end time, number of frames in the sections and bytes in the sections are compiled. At a user computer remote from the network monitoring computer, a histogram is stored. The histogram includes, for substantially all of the captured network traffic, start time, end time, total frames and total bytes. For the sections, the histogram includes the information about the sections.

Another embodiment of the invention includes a network monitoring system useful for capturing and organizing network traffic for analyzing the network traffic. The network traffic is transmitted in frames on the network. The network monitoring system includes a network monitoring computer. The network monitoring computer includes an interface configured to connect to a network. The network monitoring computer also includes a capture device connected to the interface. The capture device is configured to capture network traffic. The network monitoring computer is configured to store captured network traffic in sections. The network monitoring system further includes a user computer remote from the network monitoring computer. The user computer is connected to the network monitoring computer. The user computer stores a histogram. The histogram includes, for substantially all of the captured network traffic: start time, end time, total frames and total bytes. The histogram also includes for the sections information including: start time, end time, number of frames in the sections and bytes in a section. The user computer is configured to present a user with a graphical user interface representation in the form of a histogram of the network traffic by using the data points and graphing byte density over time.

Advantageously embodiments of the invention reduce the amount of captured network traffic that must be sent to a remote user to troubleshoot high speed network problems. Embodiments of the invention also provide a file system for organizing captured network data and facilitating a graphical display of network traffic over time.

These and other advantages and features of the present invention will become more fully apparent from the following description and appended claims, or may be learned by the practice of the invention as set forth hereinafter.

### BRIEF DESCRIPTION OF THE DRAWINGS

In order that the manner in which the advantages and features of the invention are obtained, a more particular description of the invention will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a typical network topology on which the invention may be deployed;

FIG. 2 illustrates an exemplary organization of captured data;

FIG. 3 illustrates one embodiment of a graphical user interface displaying graphically a description of the contents of a histogram; and

FIG. 4 illustrates an embodiment where a user computer is located remotely from and connected through a network to the network monitoring computer that captures data traffic.

### DETAILED DESCRIPTION OF THE INVENTION

In order to resolve problems that may exist on a network, it is often necessary to analyze the network data traffic. This is achieved by storing network data in captures. As previously described, however, captures can become large in short periods of time because of data transmission rates. As a result, users such as network administrators may have to store, retrieve, process, and view large amounts of data. Embodiments of the present invention relate to systems and methods for storing, retrieving, and displaying data. Advantageously, embodiments of the present invention can reduce the amount of data that is processed,. thereby improving the ability to resolve network problems.

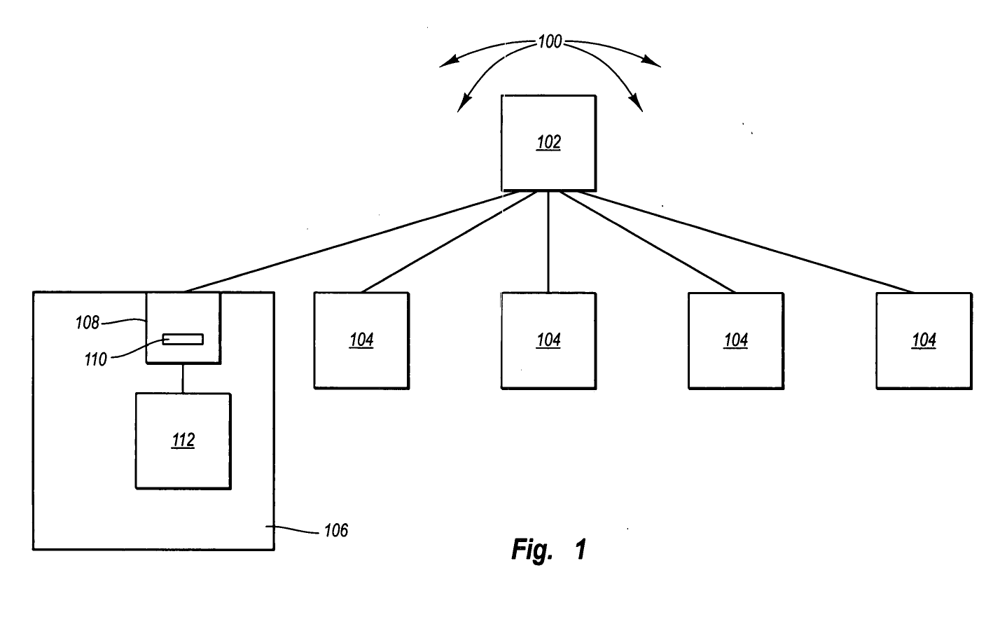

Referring now to FIG. 1, a general overview of the data capture operation of one embodiment of the invention is shown. FIG. 1 shows one network topology 100 on which the present invention may be used although one of skill in the art can appreciate that a network may include, but is not limited to, Local Area Networks, Wide Area Networks, the Internet, and the like or any combination thereof. The network topology 100 may also be either a wired and/or wireless network. In this example, a network switch or router 102 controls the flow of network data to client computers 104. A network monitoring computer 106 is used by the network administrator to detect and solve transmission problems existing on the network. The network monitoring computer 106 has a capture device 108 that captures and processes or analyzes all of the network traffic during, for example, selected periods of time.

To initiate the analysis process and to troubleshoot transmission problems existing on the network, the network monitoring computer 106 performs a capture operation to collect data on the network. During the capture operation, data is streamed from the interface (e.g. a network adapter card) of the capture device 108 to a memory buffer 110 on the capture device 108. The data is captured as raw data into data blocks. The sizes of the captured data blocks do not necessarily correspond to packet size. In this embodiment, each of the packets in the data blocks is marked with a counter value, indicating the number of clock ticks since the capture was started.

When data is collected, the data blocks are often streamed from the memory buffer 110 on the capture device 108 to a disk or other mass storage 112 that is external with respect to the capture device 108 and has more storage capacity. The process of physically storing the data to the mass storage 112 is governed by the technology of the software and hardware provided by the disk manufacturer. For example, the data is often stored in 512-byte sectors on the mass storage 112.

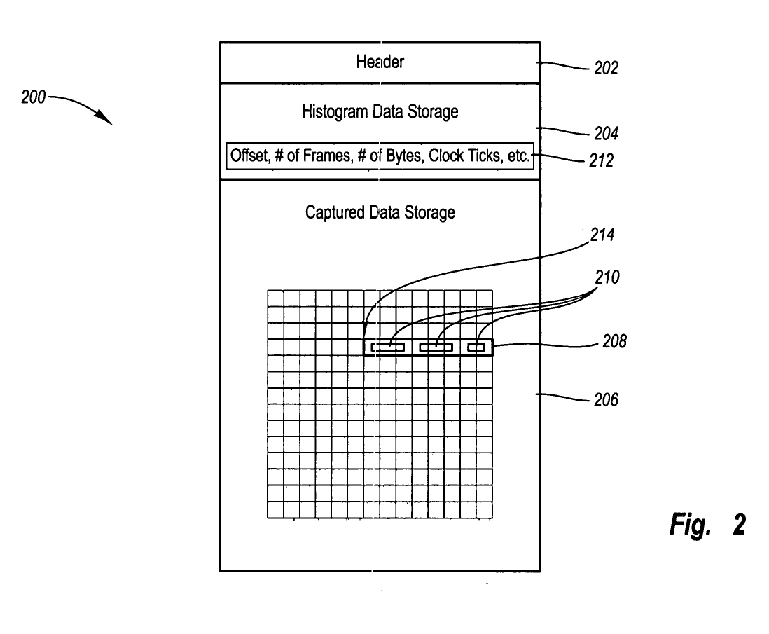

In one embodiment, the network administrator is able to retrieve and analyze the captured data in an order that can be determined by the network administrator. In other words, the network administrator is not limited to retrieving the captured data in a sequential manner. This is achieved, in one embodiment, by organizing the captured raw data into logical blocks that are referred to herein and shown in FIG. 2 as datums 208. In one embodiment, each logical block corresponds to a datum 208. A datum 208 may include one or more physical sectors on the mass storage 112 or storage device on which the datum 208 is stored and may contain one or more frames 210 of data from the network. Each datum 208 has a corresponding datum header that describes information concerning the datum 208. The information described in a particular datum header may include the number of frames (or packets) captured in the corresponding datum 208, the number of bytes contained in the frames 210 and a count of the clock ticks since the initiation of the capture operation in which the data in the particular datum 208 was captured.

During the capture operation, a set of data points 212 are stored at various offsets or numbers of bytes into the captured data. A data point 212 includes an offset of the first frame of a datum in the mass storage 112 and the datum header information corresponding to the data point 212. This information is recorded as part of a capture such as the capture shown in FIG. 2 and designated generally as 200. The offset of each data point is recorded to create a compilation of the datum header records as the raw data is written to the mass storage 112. Once the capture operation is complete and the raw data is written to the mass storage 112, the data points and each of their respective datum headers are also written to the histogram data storage area 204 of the new capture 200.

According to one embodiment of the invention, the newly created capture stored on disk or other suitable medium, is logically divided into three parts, including a capture header 202, the aforementioned histogram data storage 204 and captured data storage 206. The capture header 202 contains information related to the entire capture. This information may include a magic or parity string used to verify the validity of the data on the mass storage 112, the capture device 108 speed when the capture occurs, the starting time and stopping time of the capture, the number of frames captured to memory buffer 110 on the capture device 108, the number of frames stored from memory buffer 110 onto the mass storage 112, whether the captured data is sliced or truncated, and the length of the slice or truncation of the data, if applicable.

The histogram data storage 204 may contain the offset and datum header for each datum in the captured data. Captured data storage 206 contains the captured data frames 210 in the form of raw data. Each frame 210 may have a packet header, packet data and optional padding. The capture 200 continues to fill with raw data until the mass storage 112 is full or the network administrator stops the capture process.

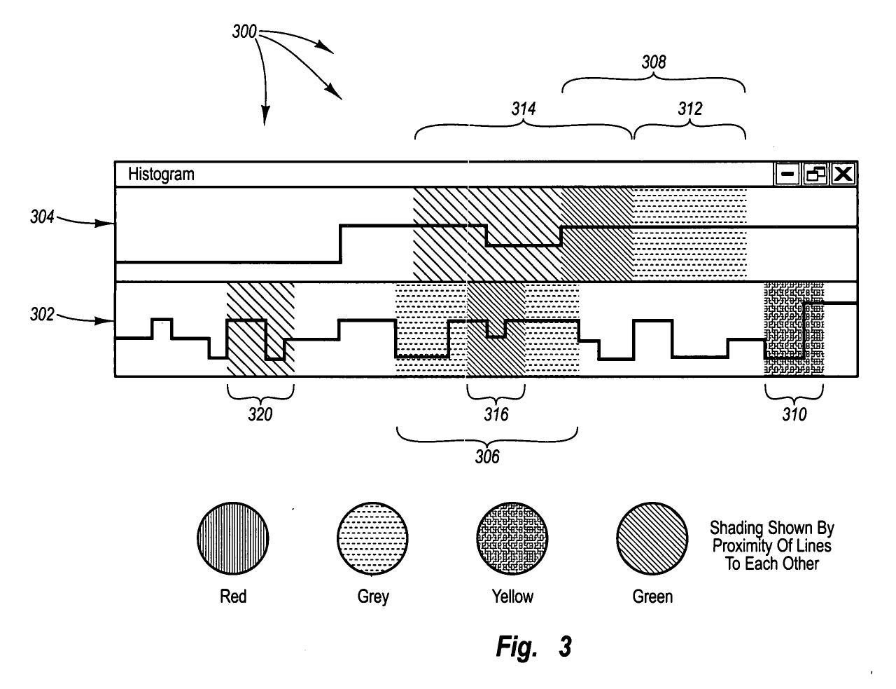

From the capture header 202 information and histogram data storage 204, a graphical user interface (GUI) representation of the capture data can be generated by graphing byte density over time in a histogram, such as is shown in FIG. 3 by the GUI designated generally as 300. The information needed to display the graph of GUI 300 is smaller than the full volume of the captured data. Thus, the information associated with GUI 300 can be transmitted to a computer used by the network administrator in a short amount of time, whether the network administrator is located locally or remotely with respect to the capture device 108 or the mass storage 112. The GUI 300 presents a summarized view of parameters or characteristics of the captured data and enables the network administrator to make an informed decision. The GUI 300, for example, helps identify a subset, or segment, of the captured data that is to be processed and displayed in more detail, as described in greater detail below.

To enable the network administrator to select a capture segment of the captured data for further analysis, the GUI 300 presents a histogram to a network administrator as described above. In this example, a portion of the histogram is represented in a data selection window 308 of FIG. 3, which highlights a segment of the histogram that graphically represents selected parameters or characteristics of the captured data. The operation of data selection window 308 and its relationship with other portions of GUI 300 will be described in greater detail below. The width of the data selection window 308 can be adjusted to increase or reduce the size of the capture segment selected by the network administrator. When a capture segment is selected in the histogram, the selected capture segment coordinates defined by the corresponding highlighted segment of the histogram are translated into beginning and end location addresses in the capture data storage 206 section of the capture 200 on mass storage 112 or another storage device using the data points in the histogram data storage area 204 of the capture 200. An analysis engine associated with the capture device 108 then formats only the raw data from the beginning location address to the end location address and calculates packet timestamp values from the stored clock tick counts. The capture segment is then passed to the GUI 300 for protocol decoding and display.

In this manner, network administrators can navigate through large amounts of captured data without processing the full volume of captured data and/or transmit the full volume of captured data from the capture device to a computer that is used to display analysis information to the network administrator. As shown in FIG. 3, the initial data transmitted to the computer associated with the network administrator is represented graphically by two interdependent graphs or histograms. The capture histogram 302 represents the entire captured data set. Within this capture histogram 302 is a zoom window 306 that the network administrator can drag for navigation to highlight a segment of the capture histogram. The width of the zoom window 306 in the capture histogram 302 is defined to encapsulate a subset, such as 10 percent, of the bytes of the entire volume of captured data. For example, if there are 256 GB of captured data, the zoom window 306 on the capture histogram 302 in this example represents 25.6 GB of data. Once the zoom window 306 is positioned and released in the capture histogram 302, a zoom histogram 304 graphically represents the span of data highlighted and defined by the zoom window 306 in the capture histogram 302.

A capture viewer is a control used to display the actual packets that are selected using the selection window 308. After the segment is selected using the capture histogram as described above, the corresponding packets are obtained, decoded and displayed using the capture viewer. The network administrator can move or dock the GUI 300, with its histograms, to any location on the screen or hide them altogether. FIG. 3 shows an undocked zooming histogram 304 and capture histogram 302. Each histogram in this example is arranged with time along the horizontal axis and bytes along the vertical axis. The zoom histogram 304 is a slave to the capture histogram 302. The zoom histogram 304 serves for fine-tune navigation and additional zooming functionality. The width of the data selection window 308 on the zoom histogram 304 is not predefined, but is network administrator configurable. The width may be determined to be equal to a number of bytes as defined by the network administrator.

The zoom histogram 304 has the ability to zoom out using a computer mouse via a Ctrl+left-double-click and a zoom-in via a left-double-click action or by any other suitable user input mechanism. The amount of zoom is user defined with a default of 80 percent. For example, with an 80 percent zoom, a left-double-click in the zoom histogram window causes the middle 80 percent of the previous data to remain with 10 percent shaved off either end. A click-drag-release operation allows the network administrator to manually fine tune the data selection window 308 by selecting an edge and dragging it, thereby increasing or decreasing the size of the data selection window 308 dynamically.

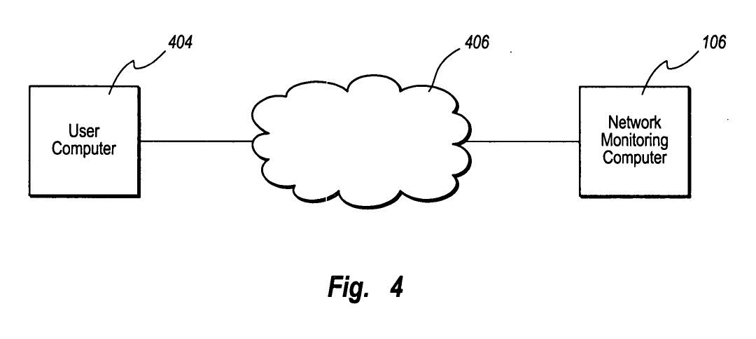

The captured data frames are often stored on a remote capture device or other remote storage medium and must be gathered to a local computer available to the user for inspection and analysis. The distance between the captured data frames and a computer used for inspection and analysis can be across a building, city, etc. To solve network problems quickly and efficiently, it is useful to optimize the data sent to the local computer by only sending the most desirable portions of the captured data frames. Selected portions are transported through a network to the user computer operated by the network administrator as is shown in FIG. 4, which illustrates a user computer 404 connected through a network 406, such as the Internet or some other wide-area network, to a network monitoring computer 106. Notably, network 406 may be the same or a different network than the network for which data frames are captured. Data frames may be captured on a local area or private wide-area network, whereas network 406 may include the Internet or some other wide-area network. As discussed previously, to send the entire volume of captured data frames requires that huge amounts of data be transmitted from the network monitoring computer 106 to the user computer 404. Such a file transfer may be at best inconvenient considering that the transmission rates across the network 406. When the network 406 is a network such as the Internet, using connections such as those shown in FIG. 4 are often limited to 1.5 Mbits per second. In one embodiment, only segments of the captured data frames present on the network monitoring computer 106 are sent across the network 406 to the user computer 404.

To scale large amounts of captured data, a compression algorithm may be applied. For example, if 256 GB of data is captured and the granularity of data points represented in the graph is every 10 MB, the capture histogram 302 needs to display 25,600 data points. The 25,600 data points take too long to draw and are not functionally presentable. To solve this graphics problem, the compression algorithm is employed for cosmetic data improvement. The same compression algorithm is also applied to the zoom histogram 304 when there is a large amount of data and a corresponding large number of data points.

Using the zoom window 306 on the local user computer 404, the network administrator selects the data represented by the entire zoom histogram 304. In the zoom histogram 304, there is a subsequent data selection window 308. The data selection window 308 in the zoom histogram 304 can be used to select portions of the captured data for viewing by the network administrator. The network administrator uses the data selection window 308 to identify the specific section of the captured data frames (stored locally or remotely) to process and analyze. When data is captured and stored remotely, the data represented in the data selection window 308 that is not already stored on the user computer 404 is transported from the remote device, such as the network monitoring computer 106, and stored temporarily on a local personal computer, such as the user computer 404. For example, the data frames may be stored in a cache area on the user computer 404. The size of this cache area may be user defined. The sections of the captured data frames that are processed and stored in the defined cache area or other storage location local to the user computer 404 are identified in the GUI 300 using an indicator such as the color shading as depicted in FIG. 3. While color shading is used in this example, other indicators may be used as well, and are within the scope of embodiments of the invention. In this example, green represents the sections of captured data frames that have been stored on the user computer 404 and made available for display and viewing on the user computer 404 at a later time. One of skill in the art can appreciate that other indicators, codes, color schemes or graphical representations can be used with a similar effect. Once an appropriate area representing data has been selected in the data selection window 308, the network administrator can request that the data frames be downloaded and made available for display by using some type of select command. Such a command may be double clicking the data selection window 308, a right-click selection of the data selection window 308, or any other suitable select command.

The software used to display the actual frames once they are selected in the histogram is a separate software control referred to herein as the capture viewer. After the segment is selected using the histogram as described above, the corresponding frames are obtained and are decoded and displayed using the capture viewer.

After initial analysis, it is common for the network administrator to want to save the retrieved sections of the remote captured data frames to a local disk or other computer readable medium for future reference. When saving the data frames to disk, the data frames are saved in a data structure that may include files such as a histogram (.hst) file and one or more downloaded captured data (.cap) files.

The .hst file is formatted into two parts. The first part is information used to display the GUI 300 appropriately. The first part contains for all of the captured data frames information such as start time, end time, total frames and total bytes. For each section of captured data, i.e. each data point, the first part includes the start times, end times, number of frames and bytes/sec. The second part of the .hst file includes a listing and description of the sections of captured data that are available in the individual .cap files. The description of the sections of captured data available in the .cap files include the .cap file name, start time, end time, total packets, and total bytes. Individual sections of captured data are saved as separate cap files as the network administrator selected them in the GUI 300. In FIG. 3, just as the data frames represented in the zoom window 306 is the same represented data that populates the zoom histogram 304, in this example, the data frames represented by the green shaded areas 314 and 316 are the same data frames and are, therefore, saved as a single .cap file. The green shaded area represented by 320 is from a previous, yet similar selection and retrieval process, and is saved in its own .cap file. Saving the data represented by the GUI 300 will result in the creation of one .hst file and two .cap files representing the green data areas in 316 and 320 respectively.

FIG. 3 illustrates a snapshot of a capture histogram GUI 300 at a particular time in the troubleshooting process. As such, various data representations are made. For example, the green area 314 represents data frames that may have been downloaded from a network monitoring computer 106. FIG. 3 now shows a new zoom and select operation using the data selection window 308. After the present zoom and select operation is complete, the data frames represented by the gray area 312 will have been downloaded from the network monitoring computer 106. The green area 314 would be expanded to include the data represented by the gray area 312. After the present select and retrieval operation, the data in the expanded green area 314 that includes the data of the gray area 312 would be combined and stored as a single .cap file on the user computer 404. In other embodiments of the invention, a cap file may be saved individually for each retrieval process. Those of skill in the art recognize that various combinations of files may be used that are still within the scope of embodiments of the present invention.

The process of creating and archiving the .hst and corresponding .cap files is done by copying the .cap files from the cache area to a local disk. When the selected .cap files are to be saved to a local disk for the first time, they may be saved in a data structure that includes a top-level folder with the same name as the .hst file in one embodiment of the invention may be created. This top-level folder is organized in the file structure of the local disk such that in one embodiment of the invention it appears in the same location as the .hst file, meaning that it has the same file path. This top-level folder contains all the individual sections of captured data saved as .cap files. In this example, these individual .cap files may use the beginning timestamp for names, prefixed by the name of the .hst file for differentiation. If the volume of captured data frames is greater than the storage available on the local disk, then only portions of the captured data frames may be archived locally.

Users are also able to open existing .hst files. A GUI 300 is populated from the details available in the .hst file. In addition, the sections of captured data that are available in the .cap files are displayed on the GUI 300 by using, for example, a green color coded section. The other parts of the GUI 300, for which there is no saved data, are disabled. When a network administrator opens a .hst file that encompasses multiple .cap files, the network administrator can view parts of the captured data frames irrespective of which .cap file the data frames are stored in. In this way, the network administrator is not required to merge or split .cap files to view the captured data frames.

When a network administrator opens a local .hst file stored on a user computer 404 and is also actively connected to a remote network monitoring computer 106 with available captured data, one embodiment of the invention can determine if the captured data on the network monitoring computer 106 correlates with the .hst file saved locally to disk. This determination is done using timestamps in one embodiment of the invention. If the timestamps match, then a relationship is established between the .hst file and the captured data frames on the network monitoring computer 106. The network administrator is able to use the GUI 300 that has just been opened to renavigate any portions of the captured data that continue to remain on the network monitoring computer 106. If the .hst file is not associated with the captured data frames on the network monitoring computer 106, the GUI 300 may be opened in a separate window not associated with the data on the network monitoring computer 106.

In another embodiment of the invention network administrators may open the individual .cap files directly. In this case, a corresponding .hst file is created just for that .cap file. In one embodiment of the invention, when viewing a .hst file which points to .cap files or sections of captured data frames that are no longer available, corrupted, or lost, those sections in the histogram are shaded a specified color, e.g. the yellow shaded area 310.

Using the above disclosed to methods and apparatus a network administrator is able to view and process large captures existing locally or on a remote network monitoring computer without the need for prohibitively expensive equipment or the time-consuming practice of processing the entire volume of captured data and transporting the entire volume of captured data to a local user computer. This is especially useful when the capture is extremely large as is often the case in today's high-speed networks. By processing only the data frames needed by the network administrator and transporting only sections of the data frames required by the network administrator, the monitoring and troubleshooting experience is made more efficient and less frustrating for the network administrator.

The present invention may be embodied in other specific forms without departing from its spirit or essential characteristics. The described embodiments are to be considered in all respects only as illustrative and not restrictive.

What is claimed is:

1. A method of analyzing network traffic on a network, the network traffic having been captured at a network monitoring computer during a period of time, the method comprising:
at a user computer remote from the network monitoring computer, receiving data points corresponding to the captured network traffic, the data points comprising:
for the captured network traffic, start time, end time, total frames and total bytes; and
information about sections of the captured network traffic, the information including start time, end time, number of frames in the section and number of bytes in the section; and
storing a histogram, including the data points, at the user computer.

2. The method of claim 1, further comprising at the user computer, presenting a user with a graphical user interface representation of the network traffic by graphing byte density over time in a capture histogram by using the histogram.

3. The method of claim 2, wherein presenting a user with a graphical user interface representation of the network traffic comprises:
including a zoom window, the zoom window useful for highlighting a segment of the capture histogram; and
representing the segment of the capture histogram in a zoom histogram.

4. The method of claim 3, further comprising:
including a data selection window useful for highlighting a segment of the zoom histogram;
storing a first downloaded captured data file that includes sections corresponding to the segment of the zoom histogram highlighted by the data selection window; and
displaying data frames corresponding to the highlighted segment of the zoom window.

5. The method of claim 4, further comprising storing a second downloaded captured data file that includes sections corresponding to a segment of the zoom histogram previously highlighted by the data selection window.

6. The method of claim 4, further comprising storing the first downloaded captured data file and the histogram together in a folder.

7. The method of claim 2, wherein presenting a user with a graphical user interface representation of the network traffic comprises applying a compression algorithm to at least a portion of the information in the histogram.

8. The method of claim 3, wherein representing the segment of the capture histogram in a zoom histogram comprises applying a compression algorithm to at least a portion of the information in the histogram.

9. The method of claim 4, the histogram further comprising a listing and description of downloaded captured data files stored on the user computer, the method further comprising using the listing and description of downloaded captured data files to code portions of the capture histogram and the zoom histogram with a first indicator representing sections stored at the user computer.

10. The method of claim 4, further comprising coding portions of the capture histogram and the zoom histogram with a second indicator representing sections that were previously at the user computer, but that are not presently at the user computer.

11. The method of claim 4, further comprising coding portions of the capture histogram and the zoom histogram with a third indicator representing sections that are not stored at the user computer or at the network monitoring computer.

12. The method of claim 4, the histogram further comprising a listing and description of downloaded captured data files stored on the user computer, the method further comprising:
using the listing and description of downloaded captured data files to color code portions of the capture histogram and the zoom histogram with a first color representing sections stored at the user computer;
color coding portions of the capture histogram and the zoom histogram with a second color representing sections that were previously at the user computer, but that are not presently at the user computer; and
color coding portions of the capture histogram and the zoom histogram with a third color representing sections that are not stored at the user computer or at the network monitoring computer.

13. The method of claim 4, further comprising:
downloading sections from the network monitoring computer that are not stored in downloaded captured data files at the user computer; and
combining the downloaded sections with a downloaded captured data file that was previously stored at the user computer.

14. The method of claim 1, further comprising saving the histogram for later use.

15. The method of claim 14, further comprising:
opening the histogram;
determining if the histogram corresponds to network traffic stored on the network monitoring computer using timestamps;
if the histogram corresponds to network traffic stored on the network monitoring computer, establishing a relationship between the network monitoring computer and the user computer such that network traffic existing on the network monitoring computer may be downloaded to the user computer.

16. The method of claim 4, comprising saving a downloaded captured data file stored on the user computer for later use.

17. The method of claim 16, comprising:
creating an individual histogram for the downloaded captured data file stored on the user computer for later use; and
displaying the individual histogram at the user computer.

18. A computer readable medium with instructions for performing the method of claim 1.

19. A method of managing captured data from a network, the method comprising:
receiving a portion of the captured data from a remote network monitoring computer;
storing at least one downloaded captured data file comprising the portion of the captured data, the captured data organized into sections;
storing a histogram, the histogram comprising:
a first part containing:
for all of the captured data, information including start time, end time, total frames and total bytes;
for each of the sections, start times, end times, number of frames and bytes/sec; and
a second part that includes a listing and description of the sections that are available in downloaded captured data files.

20. The method of claim 19, further comprising displaying a graphical user interface representation of the network traffic using information in the histogram.

21. The method of claim 20, wherein displaying a graphical user interface representation of the network traffic comprises graphing byte density over time.

22. The method of claim 20, further comprising:
displaying a data selection window that allows a user to select a portion of the graphical user interface representation representing a portion of the captured data that the user desires to view;
in response to a user selecting a portion of the graphical user interface representation, downloading sections of the captured data that are not stored in downloaded captured data files; and
storing the downloaded sections of the captured data in a downloaded captured data file.

23. A computer readable medium having a plurality of data fields representing a data structure, the computer readable medium comprising:
a first data field containing data representing a histogram used to display a graphical user interface representing byte density of captured data over time, the histogram comprising, for substantially all of the captured data, start time, end time, total frames, and total bytes and for sections of the captured data, start times, end times, number of frames and bytes per second;
a second data field containing at least section of captured data stored as at least one downloaded captured data file representing sections of captured data; and
a third data field containing data representing a top-level folder for organizing the first data filed and the second data field into a file structure.

24. The computer readable medium of claim 23, the top level folder having the same name as the histogram.

25. The computer readable medium of claim 23, the top-level folder being in the same location as the histogram.

26. The computer readable medium of claim 23, at least one of the downloaded captured data files having a name that includes the captured data start time for the section captured data stored at the downloaded captured data file.

27. The computer readable medium of claim 23, at least one of the downloaded captured data files having a name that includes the name of the histogram.

28. The computer readable medium of claim 23, the histogram being created from a downloaded captured data file in response to a downloaded captured data file being opened directly.

29. The computer readable medium of claim 23 at least one of the downloaded captured data files being formed from a plurality of downloaded captured data files.
